(19) United States
(12) Patent Application Publication
(10) Pub. No.: US 2014/0188784 A1
(43) Pub. Date: Jul. 3, 2014

(54) SYSTEMS AND METHODS FOR DATA-WAREHOUSING TO FACILITATE ADVANCED BUSINESS ANALYTIC ASSESSMENT

(71) Applicant: Joseph Guerra, Cheshire, CT (US)

(72) Inventor: Joseph Guerra, Cheshire, CT (US)

(21) Appl. No.: 13/842,232

(22) Filed: Mar. 15, 2013

Related U.S. Application Data
(60) Provisional application No. 61/746,951, filed on Dec. 28, 2012.

(51) Int. Cl. G06F 17/30

(52) U.S. Cl. CPC G06F 17/30563
USPC 707/602

(57) ABSTRACT

Certain embodiments contemplate systems and methods for improving the speed and efficiency of a data warehouse. In some embodiments, an ETL process is modified to perform a joined indexing operation which reduces the number of lookup requests required. Certain embodiments contemplate a date dimension and hierarchical data structure which improve operation speed. Still other embodiments contemplate structural organizations of biographical fact tables to better improve data access.

### CROSS REFERENCE TO RELATED APPLICATION

This application claims priority to U.S. Provisional Application No. 61/746,951 filed Dec. 28, 2012. This application is incorporated herein by reference in its entirety.

### BACKGROUND OF THE INVENTION

Data warehouses provide systems for storing and organizing data that organizations use to plan and conduct business operations, for example. Data is organized using extraction, transform and load (ETL) operations to enable use of computer systems to access data for specific organizational needs. However, as the amount and complexity of data increases, existing tools are inadequate to provide access to the types of data that businesses need to conduct operations at the pace that is now required. Unfortunately, existing data warehouses are not a panacea for all business needs. Particularly, many warehouses are inefficient in their implementation and perform conventional operations in a manner which may render the system impractical for dealing with large datasets in a timely manner. There exists a need for novel systems and methods to improve data warehousing operations and to better coordinate data organization for analysis, input, and retrieval.

### SUMMARY OF THE INVENTION

Data warehouses typically maintain a copy of information from source transaction systems. This architecture provides the opportunity to perform a variety of functions. For example, the warehouse may be used to maintain data history, even if the source transaction systems do not maintain a history. The warehouse may also integrate data from multiple source systems, enabling a central view across the enterprise. This is particularly valuable when the organization has grown by one or more mergers, for example. A warehouse can also restructure the data to deliver excellent query performance, even for complex analytic queries, without impacting the transactional database systems. A warehouse may also present the organization's information in a consistent manner and restructure the data so that it makes sense to the business users. A warehouse may provide a single common data model for all data of interest regardless of the data's source.

In this manner the warehouse adds value to operational business applications. The warehouse may be built around a carefully designed data model that transforms production data from a high speed data entry design to one that supports high speed retrieval. This improves data quality, by providing consistent codes and descriptions, and possibly flagging bad data. A preferred embodiment of the invention uses a derived surrogate key in which an identifier is formed from field entrees in the source table in which transaction data has been positioned. Different combinations of fields can be employed to generate derived surrogate keys depending on the nature of the data and the fields in use for a given data warehouse. It is generally preferred to use a specific combination of fields, or a specific formula, to form the derived surrogate keys for a particular data warehouse. This provides for data consistency and accuracy, and avoids the look-up operations commonly used in generating surrogate keys in existing data warehouses. Preferred embodiments of the invention utilize the derived surrogate key methodology to provide faster access to more complex data systems, such as the merger of disparate source data into a single warehouse.

A preferred embodiment of the invention uses the advantages provided by the derived surrogate key methodology in a hierarchical structure that uses a hierarchy table with a plurality of customer dimensions associated with a plurality of levels of an interim table. As hierarchy reporting requirements change it is no longer necessary to alter the dimension of the hierarchy table, as the interim table can be altered to provide for changed reporting requirements. Thus, a preferred method of the invention includes altering the interim table to provide for a change in reporting without the need for changing of each dimension. A preferred embodiment includes altering a rolling format which can include, for example, resetting the offset distance to identify which level in an interim table is used to retrieve the appropriate data. Thus preferred methods involve setting the parameters such as the number of levels to be traversed in order to populate the interim table with an ETL tool. The interim table is then connected to the fact table and the dimension table to enable the generation of reports.

### BRIEF DESCRIPTION OF THE DRAWINGS

FIG. 1 is a high level representation of a data warehouse design used in certain embodiments, including a source system feeding the data warehouse and being utilized by a business intelligence (BI) toolset.

FIG. 2 is an exemplary computing device which may be programmed and/or configured to implement certain processes described in relation to various embodiments of the present disclosure.

FIG. 3 illustrates a database topology for pulling multiple Enterprise Resource Planning (ERP) data sources using an Extract, Transform, and Load (ETL) software tool. The ETL tool may obtain data from each appropriate source, including whatever ERP systems are in use.

FIG. 4 illustrates a database topology for creating a separate Central Repository (CR) for each of the separate sources that uses a separately maintained ETL process.

FIG. 5 illustrates a sample of the separate business subjects (data marts) that can be included in the data warehouse of certain embodiments.

FIG. 6 illustrates how the Accounts Receivable (AR) business subject (data mart) may be included in the data warehouse of certain embodiments.

FIG. 7 illustrates how certain embodiments move data from the separate source ERP transactional detail data stores into the AR Data Mart Fact table and the subordinate ERP specific extension tables.

FIG. 8 illustrates how certain embodiments move data from the separate source ERP transactional data stores into the Data Mart Fact Header table associated with each ERP.

FIG. 9 illustrates a method of creation and usage of system generated surrogate keys.

FIG. 10 is a flow diagram depicting certain steps in a derived surrogate key creation process.

FIG. 11 illustrates a method of creation and usage of simple derived surrogate keys based on application data in certain embodiments.

FIG. 12 illustrates a method of creation and usage of complex derived surrogate keys based on application data in certain embodiments.

FIG. 13 illustrates the method of certain embodiments for creating and using derived complex numeric surrogate keys based on application data.

FIG. 14 illustrates the method of certain embodiments for creating and using derived complex character surrogate keys based on application data.

FIG. 15 illustrates the method of certain embodiments for creating and using a source control.

FIG. 16 is a flow diagram depicting a method for providing multisource control in certain embodiments.

FIG. 17 illustrates the method of certain embodiments for using audit controls.

FIG. 18A-D illustrate various prior art methods of utilizing hierarchies.

FIG. 19A illustrates the method of utilizing hierarchies in certain of the embodiments, overcoming certain of the deficiencies of the structures of FIGS. 18A-D.

FIG. 19B is a flowchart of an exemplary method of generating an interim table.

FIG. 19C is a flowchart of an exemplary method of using an interim table.

FIG. 20 illustrates a method used in certain embodiments to build a dates dimension.

FIG. 21 is a flow diagram depicting a method used in certain embodiments to create a dates dimension.

FIGS. 22A-B show an example of the dates dimension in certain embodiments.

FIG. 23 is a flow diagram depicting steps in a process for traversing a hierarchical structure such as the Table of FIG. 19A.

FIGS. 24-31 are process flow diagrams illustrating methods of forming derived surrogate keys from selected parameters.

### DETAILED DESCRIPTION OF THE INVENTION

Preferred embodiments of the invention include systems and methods for improving the speed and efficiency of data warehouse operations. In some embodiments, an ETL process is modified to perform a joined indexing operation which may reduce the number of lookup requests required, for example. Certain embodiments contemplate a date dimension and hierarchical data structure which improve operation speed. Still other embodiments contemplate structural organizations of biographical fact tables to better improve data access.

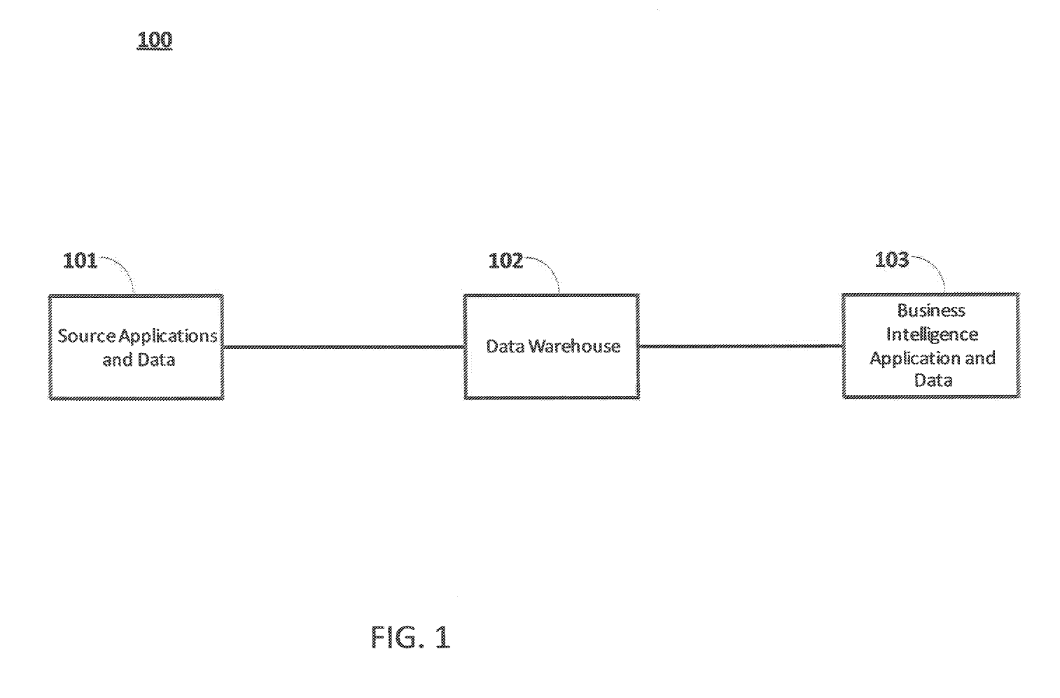

FIG. 1 depicts a high level representation of a data warehouse design 100 used in certain embodiments. A source system 101, such as an Online Transaction Processing system (OLTP), may feed data to a data warehouse 102. A business intelligence tool 103 can then use the data from the data warehouse to provide the business community or other organizations with actionable information.

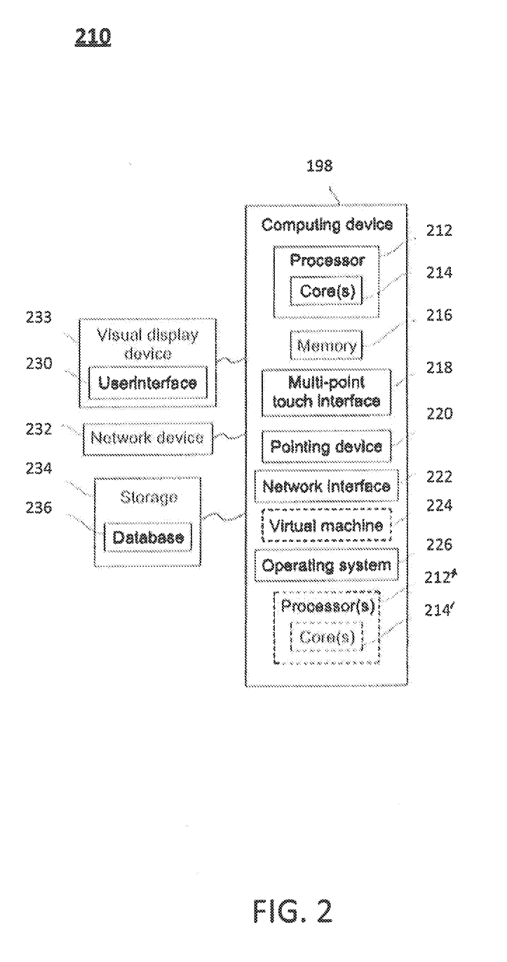

FIG. 2 is a block diagram of an exemplary computing device 210 that can be used in conjunction with preferred embodiments of the invention. The computing device 210 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 216 included in the computing device 210 may store computer-readable and computer-executable instructions or software for interface with and/or controlling an operation of the scanner system 100. The computing device 210 may also include configurable and/or programmable processor 212 and associated core 214, and optionally, one or more additional configurable and/or programmable processing devices, e.g., processor(s) 212′ and associated core(s) 214′ (for example, in the case of computer systems having multiple processors/cores), for executing computer-readable and computer-executable instructions or software stored in the memory 216 and other programs for controlling system hardware. Processor 212 and processor(s) 212′ may each be a single core processor or multiple core (214 and 214′) processor.

Virtualization may be employed in the computing device 210 so that infrastructure and resources in the computing device may be shared dynamically. A virtual machine 224 may be provided to handle a process running on multiple processors so that the process appears to be using only one computing resource rather than multiple computing resources. Multiple virtual machines may also be used with one processor.

Memory 216 may include a computer system memory or random access memory, such as DRAM, SRAM, EDO RAM, and the like. Memory 216 may include other types of memory as well, or combinations thereof.

A user may interact with the computing device 210 through a visual display device 233, such as a computer monitor, which may display one or more user interfaces 230 that may be provided in accordance with exemplary embodiments. The computing device 210 may include other I/O devices for receiving input from a user, for example, a keyboard or any suitable multi-point touch interface 218, a pointing device 220 (e.g., a mouse). The keyboard 218 and the pointing device 220 may be coupled to the visual display device 233. The computing device 210 may include other suitable conventional I/O peripherals.

The computing device 210 may also include one or more storage devices 234, such as a hard-drive, CD-ROM, or other computer readable media, for storing data and computer-readable instructions and/or software to implement exemplary processes described herein. Exemplary storage device 234 may also store one or more databases for storing any suitable information required to implement exemplary embodiments. For example, exemplary storage device 234 can store one or more databases 236 for storing information. The databases may be updated manually or automatically at any suitable time to add, delete, and/or update one or more items in the databases.

The computing device 210 can include a network interface 222 configured to interface via one or more network devices 232 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 222 may include a built-in network adapter, network interface card, PCMCIA network card, card bus network adapter, wireless network adapter, USB network adapter, modem or any other device suitable for interfacing the computing device 210 to any type of network capable of communication and performing the operations described herein. Moreover, the computing device 210 may be any computer system, such as a workstation, desktop computer, server, laptop, handheld computer, tablet computer, or other form of computing or telecommunications device that is capable of communication and that has sufficient processor power and memory capacity to perform the operations described herein.

The computing device 210 may run any operating system 226, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 226 may be run in native mode or emulated mode. In an exemplary embodiment, the operating system 226 may be run on one or more cloud machine instances.

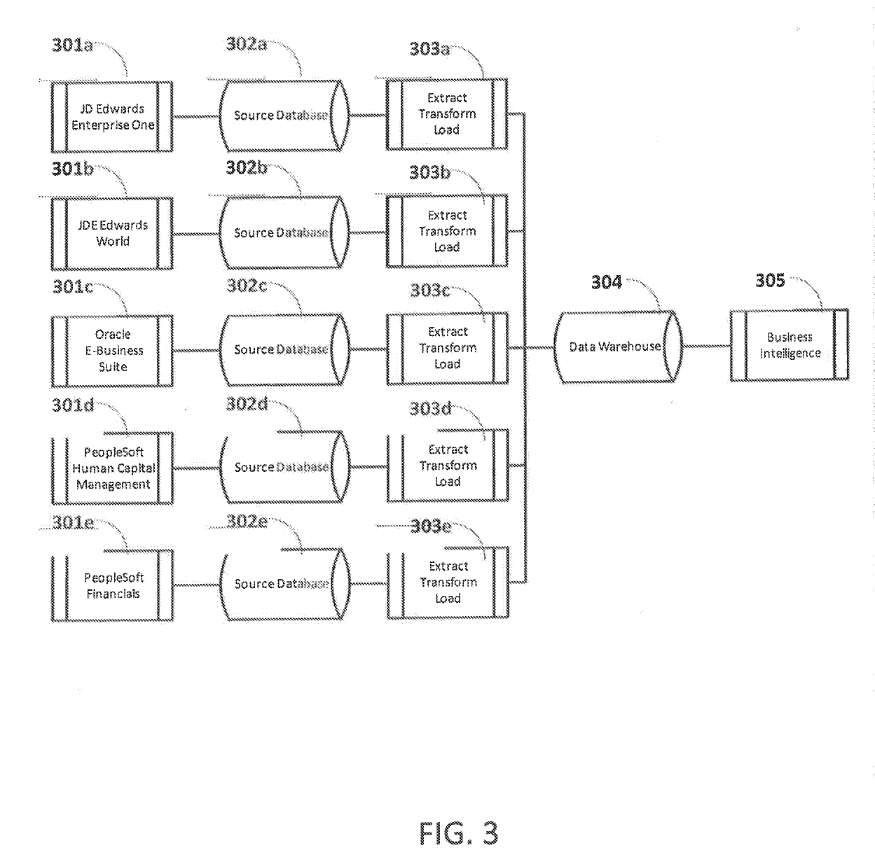

FIG. 3 illustrates a database topology for pulling multiple Enterprise Resource Planning (ERP) data sources using an Extract, Transform, and Load (ETL) software tool. The ETL tool may obtain data from each appropriate source, including whatever ERP systems are in use. Supported data sources 301a-e may include JD Edwards Enterprise One, JDE Edwards World, Oracle E-Business Suite, Peoplesoft Human Capital Management, and Peoplesoft Financials, for example. Data sources 301a-e can feed the data warehouse information. Each of the sources may be housed on a separate and distinct database 302a-e. Separate and distinct ETL processes 303a-e may be used to extract the data from each separate source system application, edit it, assign easy-to-understand names to each field, and then load the data into the Data Warehouse 304 where it can be used by the BI toolset 305.

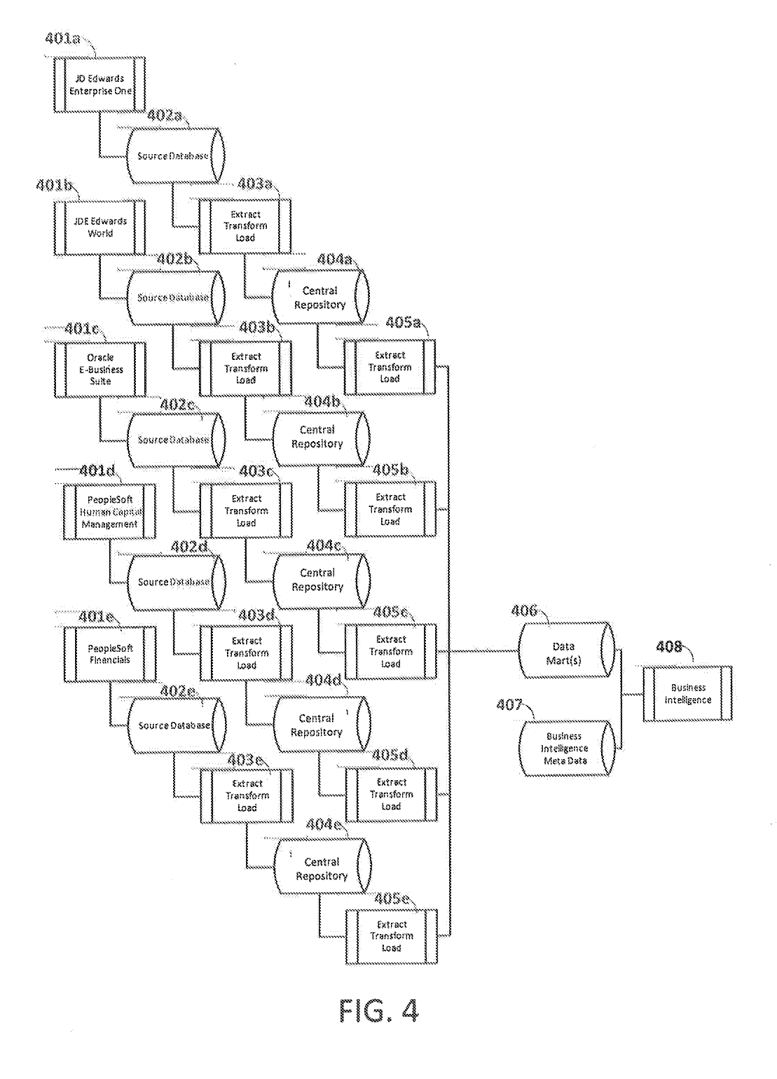

FIG. 4 illustrates a database topology for creating a separate Central Repository (CR) for each of the separate sources that uses a separately maintained ETL process. FIG. 4 illustrates a sampling of the supported data sources 401a-e that can provide data to the data warehouse, the source databases 402a-e, the ETL processes 403a-e, such as SAP Data Services ETL processes. ETL processes 403a-e may provide information to the central repository 404a-e. In some embodiments, the data that is extracted from the source system and loaded into the CR may be moved with minimal transformations, whereby table and field names can be modified to be more meaningful to a wider audience, and dates may be transformed from a numeric to date format. Every row and every field may be loaded from the required source tables to the related CR tables. Additional ETL processes 405a-e can extract, transform and load the appropriate data from the CR tables 404a-e into the data marts 406. During operation of these ETL processes many complex transformations (e.g. hierarchical derivations, complex profit analysis, parsing of strings into components) occur that improve the flexibility of the tables in the data marts allowing for the creation of the metadata 407. Metadata 407 are needed by the BI tool's 408 reports and other information delivery mechanisms. Certain embodiments include a sample set of metadata for each of the underlying data marts that are offered in the data warehouse.

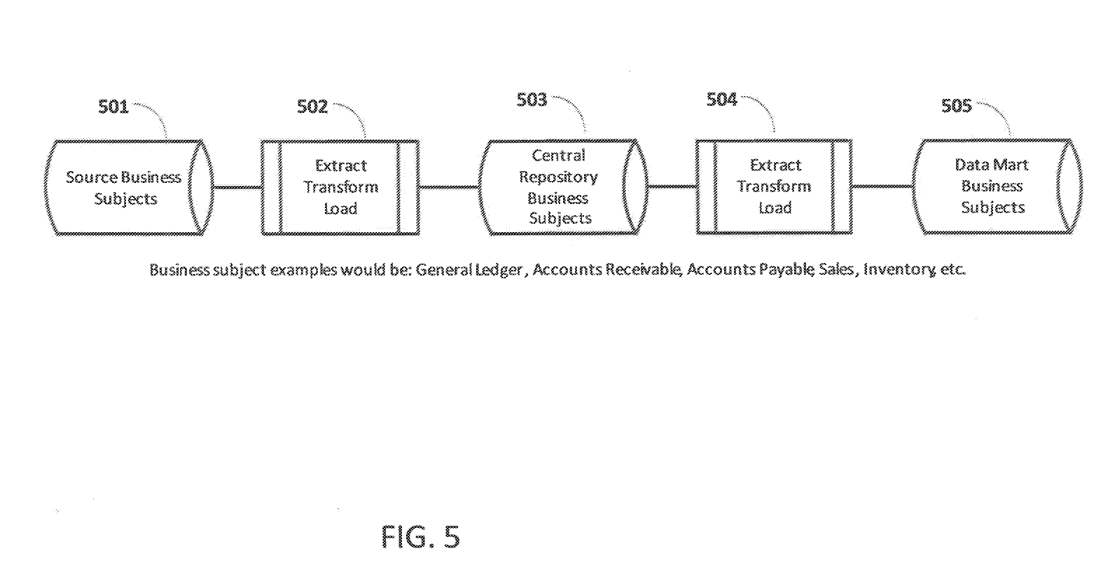

FIG. 5 illustrates a sample of the separate business subjects (data marts) 505 that can be created in the data warehouse of certain embodiments. Separate data marts may be associated with each of the separate business subjects, or “Subject Areas”, such as, e.g., Accounts Payable, Accounts Receivable, General Ledger, Inventory and Sales. In most cases, individual data marts contain data from a single subject area such as the general ledger, or optionally, the sales function.

Certain embodiments of the data warehouse perform some predigesting of the raw data in anticipation of the types of reports and inquiries that will be requested. This may be done by developing and storing metadata (i.e., new fields such as averages, summaries, and deviations that are derived from the source data). Certain kinds of metadata can be more useful in support of reporting and analysis than other metadata. A rich variety of useful metadata fields may improve the data warehouse's effectiveness.

A good design of the data model around which a data warehouse may be built, may improve the functioning of the data warehouse. The names given to each field, whether each data field needs to be reformatted, and what metadata fields are processed or calculated and added, all comprise important design decisions. One may also decide what, if any, data items from sources outside of the application database are added to the data model.

Once a data warehouse is made operational, it may be desirable for the data model to remain stable. If the data model does not remain stable, then reports created from that data may need to be changed whenever the data model changes. New data fields and metadata may need to be added over time in a way that does not require reports to be rewritten.

The separate ETL process tools 502 may read data from each source application 501, edit the data, assign easy-to-understand names to each field, and then load the data into a central depository 503 and a second ETL process 504 can load into data marts 505.

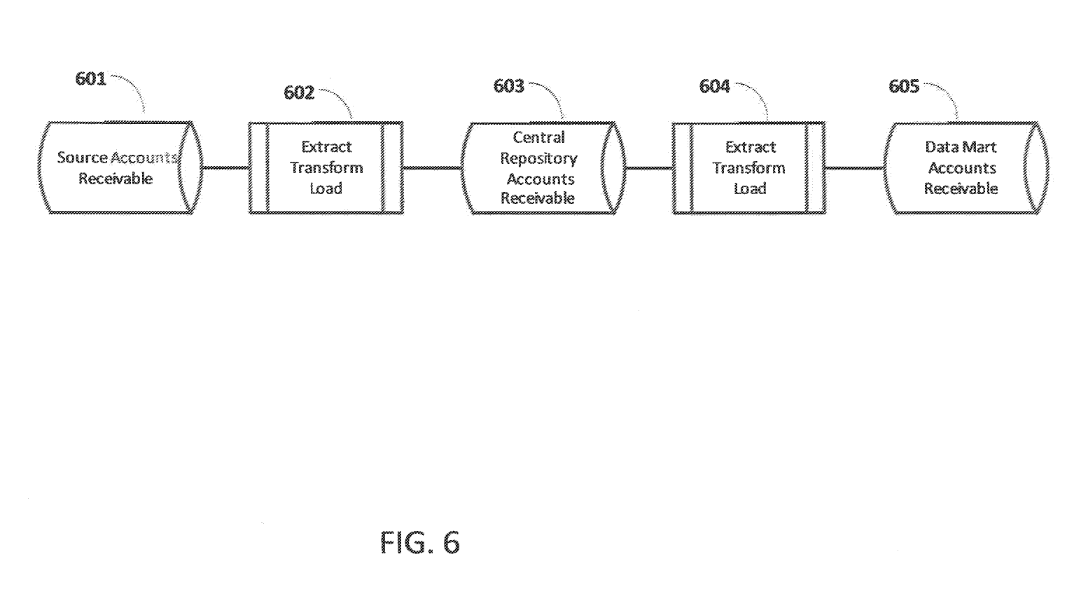

FIG. 6 illustrates how the Accounts Receivable (AR) business subject (data mart) 603 may be included in the data warehouse of certain embodiments using source data 601, a first ETL process 602 to load the data into repository 603, and a second ETL process to load into data marts 605.

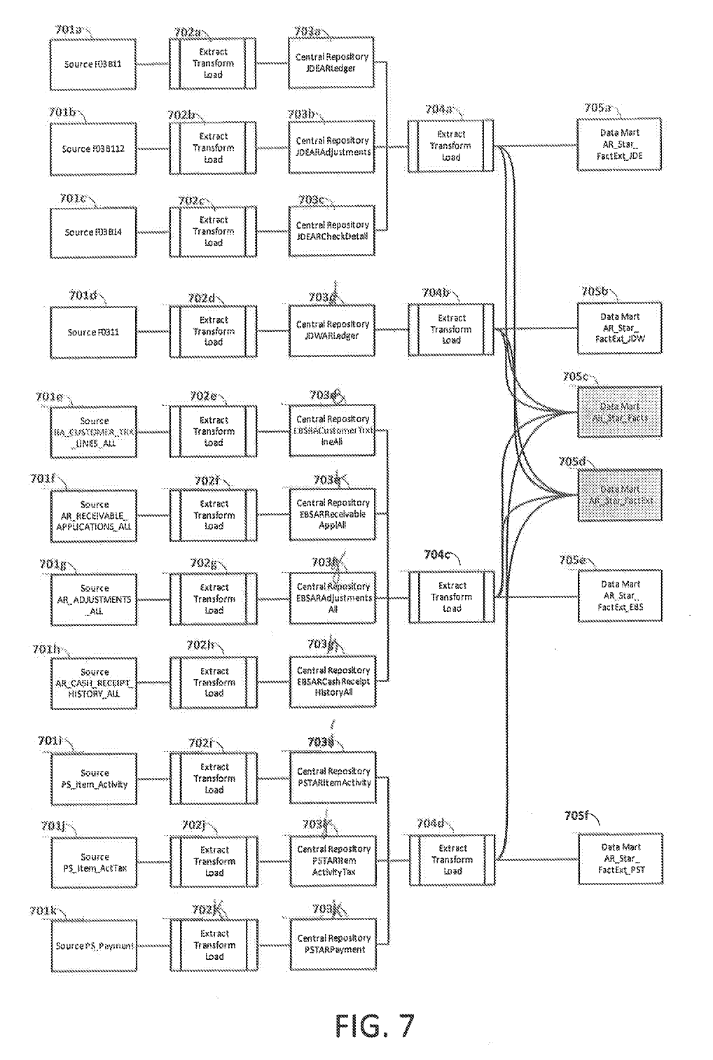

FIG. 7 illustrates how certain embodiments move data from the separate source ERP transactional detail data stores 701a-701k into the AR Data Mart Fact table 705a-705f and the subordinate ERP specific extension tables using load 702a-702k storage 703a-703k and load 704a-704d steps.

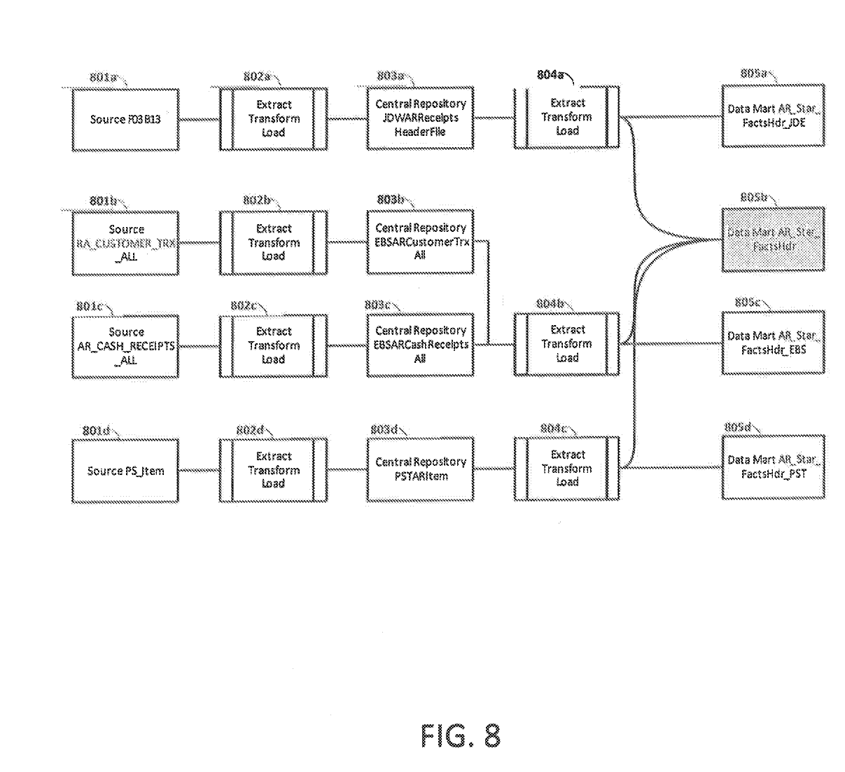

FIG. 8 illustrates how certain embodiments move data from the separate source ERP transactional data stores 801a-801d into the Data Mart Fact Header table 805a-805d associated with each ERP.

Data warehouses may include and use the source system's artificial, or system generated, surrogate keys (ASK) when building the dimension tables based on the biographical tables in the source system. The ASK may be a numeric, system-generated, field that has no meaning for the business. When the fact table is being built some systems will use the natural key elements stored in the transactional tables to retrieve the surrogate key value from the dimension. This can have a negative impact on the efficiency of fact table load process as each transaction row will entail an additional query to the dimension to pull back the ASK.

Certain embodiments, by contrast, utilize a Derived Surrogate Key (DSK), composed from other fields such as with the natural key of the biographical table in the source system. The natural key may include one to many fields in the source table. These same fields may be normally included in the transactional table and as such can join directly to the dimension table to easily retrieve desired biographical information for reporting purposes. The DSK provides data consistency and accuracy. The ASK does not provide a true level of consistency as the biographical data can change over time and can typically entail a newly generated surrogate key.

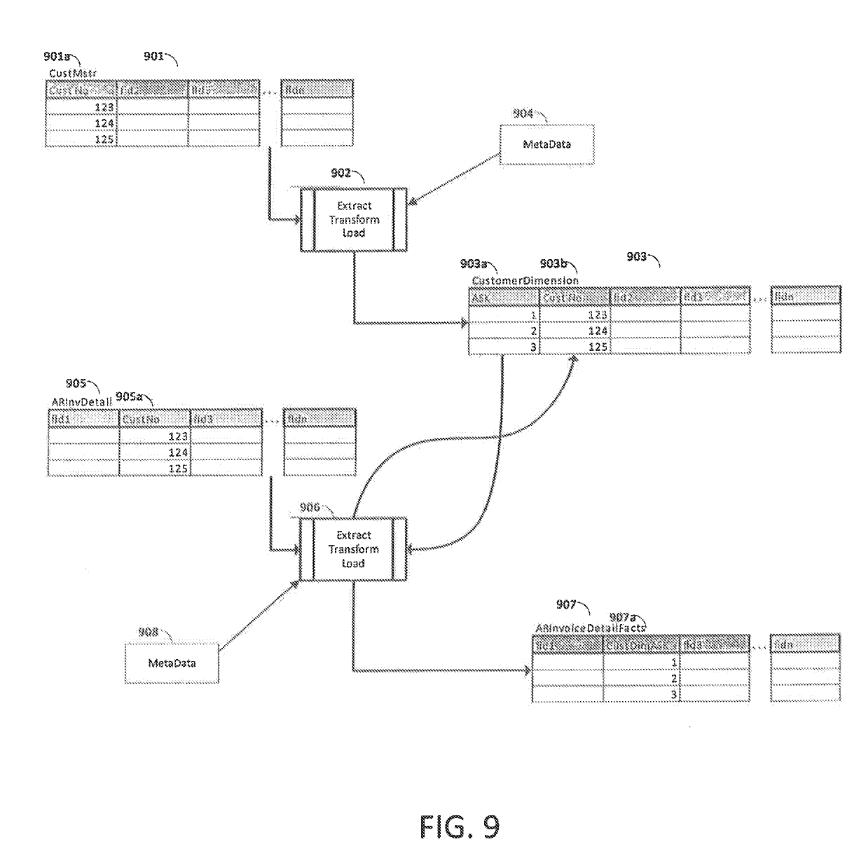

FIG. 9 illustrates a method of formation and usage of system generated surrogate keys. The method uses system generated ASKs when populating the dimension's surrogate key value into the transaction related fact table. The AR module's customer master table 901 is propagated into the customer dimension 903 using an ETL process 902. Metadata 904 may dictate the operation of ETL process 902. During the ETL process the customer number 901a may be brought over to the dimension, and an Artificial Surrogate Key 903a may be generated to identify the corresponding row in the customer dimension 903. When the AR transaction table 905 that houses the customer number is propagated into the AR Fact table 907, the ETL process 906 performs a lookup into the customer dimension 903 to retrieve the ASK 903a for storage in the fact table 901a. While this may be an efficient method for BI reporting purposes, the ETL fact table load process can be resource intensive, especially when there are a large number of rows in the source transaction table, and the lookup has to be performed for each row to bring in the ASK.

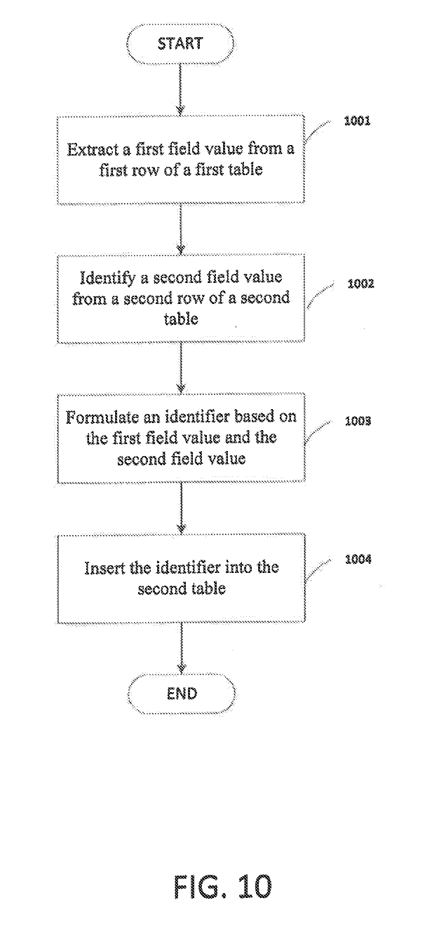

FIG. 10 is a flow diagram depicting certain steps in a derived surrogate key formation process. At block 1001 the system may extract a first field value from a first row of a first table. At block 1002 the system may extract a second field value from a second row of a second table. One will recognize that the first and second rows may appear anywhere in their respective tables. The first and second values may be alphanumeric values in some embodiments. At block 1003 the system may formulate an identifier, such as a derived surrogate key, based on the first field value and the second field value. The identifier may be formulated by concatenating the first and second values. At block 1004 the system may then insert the identifier into the second table. These operations may be performed via an ETL process configured using instructional metadata.

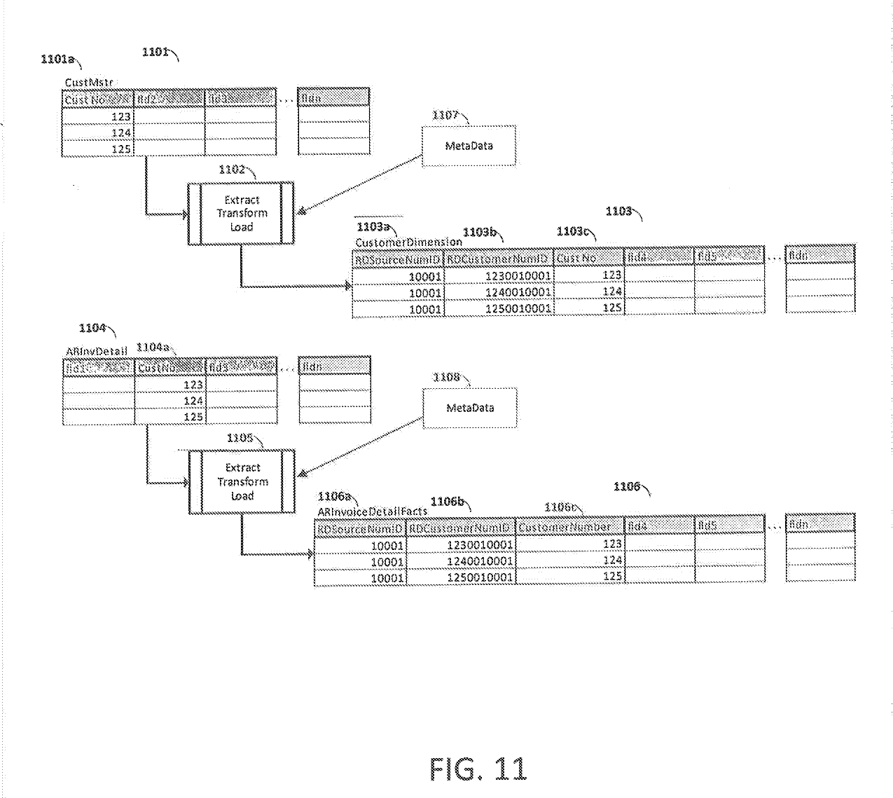

FIG. 11 illustrates a method for creating and using derived surrogate keys based on application data in certain embodiments, as generally described in FIG. 10. This method may overcome the need for as many lookups in the method of FIG. 9. The method may generate Derived Surrogate Keys (DSK) for a single numeric field identifier to create a more efficient load process for the fact tables. When building the dimension table 1103 the ETL process 1102, such as a SAP Data Services ETL process, for example, is modified to form a DSK field based on the source of the dimension table 1101 and the dimension's natural identifier. ETL process 1102 may be configured to perform this operation using metadata 1107. In this example, the DSK field may be comprised of a natural dimension identifier, in this example, Cust. No. 1103c and the RDSourceNumID. The RDSourceNumID field 1103a is discussed in greater detail below in reference to source controls. When building the fact table 1106, the ETL process 1105, which may also be SAP Data Services ETL process, that is adapted to create DSKs based on the dimension values contained within the source transaction table 1104. The DSKs can be in the same format as those in the dimension tables, RDSourceNumID 1106a and the dimension's natural identifier.

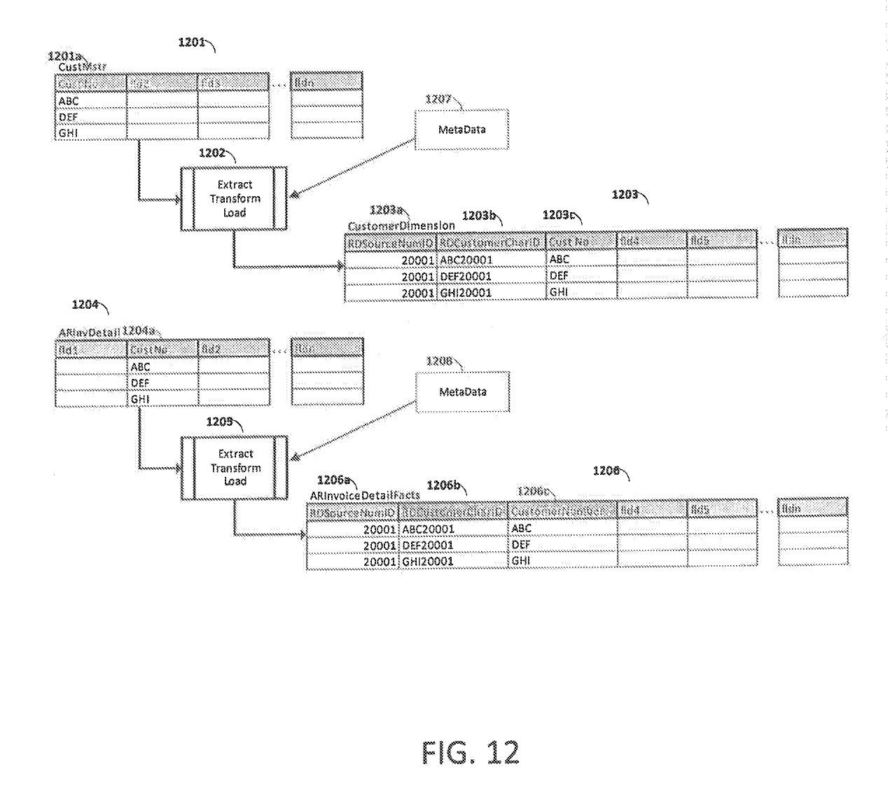

FIG. 12 illustrates a method of creation and usage of complex derived surrogate keys based on application data in certain embodiments. In this embodiment, a single character field identifier customer number 1201a, 1203c, 1204a, 1206c may be used to create the DSK.

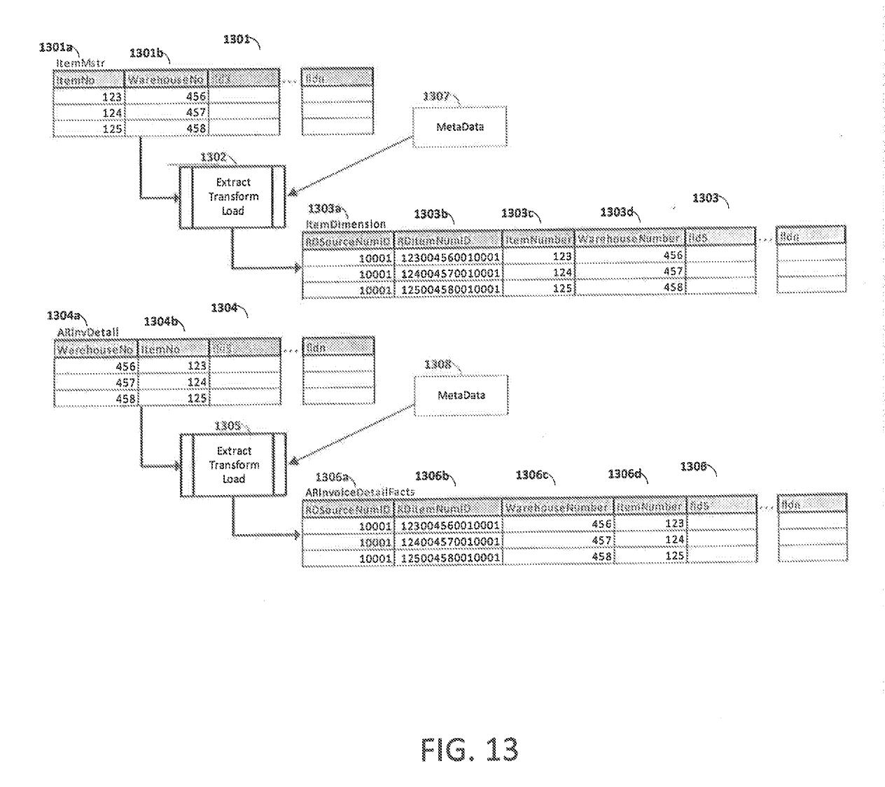

FIG. 13 shows the method of certain embodiments of forming derived surrogate keys (DSK) for a complex numeric field identifier in order to create a more efficient load process for the fact tables. When building the dimension table 1303 ETL process 1302, such as an SAP Data Services product adapted for this purpose, can form a DSK field based on the source of the dimension table 1301 and the dimension's natural identifier. The DSK field will be comprised of the natural dimension identifier, in this example, ItemNumber 1303c and WarehouseNumber 1303d, and the RDSourceNumID 1303a. When building the Fact table 1306 the ETL process 1305 may also create DSKs based on the dimension values contained within the source transaction table 1304. The DSKs are in the same format as those in the dimension tables, RDSourceNumID and the dimension's natural identifier, in this case the ItemNumber 1304b concatenated with the WarehouseNumber 1304a concatenated with RDSourceNumID 1303a.

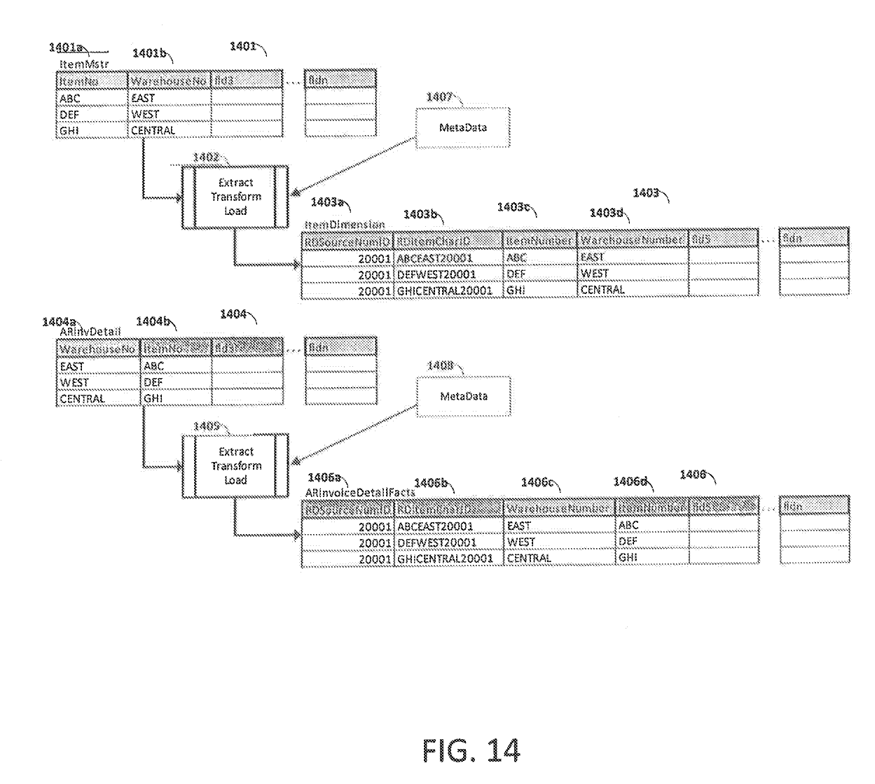

FIG. 14 is shows the method of certain embodiments of creating Derived Surrogate Keys (DSK) for a complex character field identifier in order to create a more efficient load process for the fact tables. When building the dimension table 1403 the SAP Data Services ETL process 1402, for example, is adapted to form a DSK field based on the source of the dimension table 1401 and the dimension's natural identifier. The DSK field will be comprised of the natural dimension identifier, in this example, ItemNumber and WarehouseNumber, and the RDSourceNumID. When building the fact table 1406 the ETL process 1405 will also create DSKs based on the dimension values contained within the source transaction table 1404. The DSKs will be in the same format as those in the dimension tables, RDSourceNumID 1403a and the dimension's natural identifier, in this case the ItemNumber 1404b concatenated with the WarehouseNumber 1404a concatenated with RDSourceNumID 1406a.

The derived surrogate key described in the examples of FIGS. 11-14 may help ensure consistency of the data. When updates are made to rows in the source of the dimension table a new ASK (industry standard) may be assigned to the row. When updates are made to rows in the source of the dimension table, the new rows may have the same DSK as the previous row. This may minimize the impact to system resources during Fact Table loads. It is not necessary to perform lookups to find and populate the derived surrogate key. In contrast, one must perform lookups for each loading row in the fact table to find the ASK for each of the dimensions.

Many organizations have multiple source applications, but may want all of their data in a data warehouse. The organizations may want the disparate data conformed so that they are able to report on all entities within their organization without having to write complex and resource intensive queries, which will typically involve significant IT involvement. Conforming the disparate data may be a complex process. When heterogeneous sources of data are brought together, each of the source systems will likely have different key field values for the same biographical information, as well as security issues associated with each source system.

In addition, organizations often require an ability to archive data. The effort to provide access to different source systems is a significant IT project during implementation. The effort is prolific as all data warehouse tables need to be touched. Furthermore, security issues abound when bringing separate systems together.

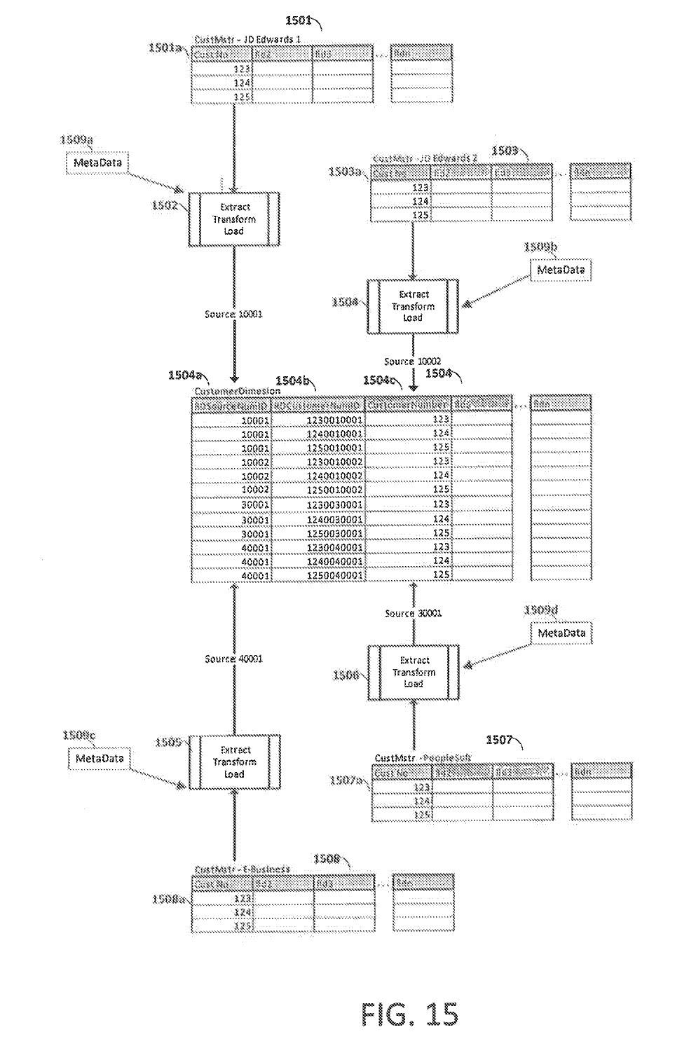

FIG. 15 illustrates a multi-tenancy feature implemented in certain embodiments to respond to certain of the above-described difficulties. The feature may require negligible field configuration. In some embodiments, the feature may be a single field within each table of the data warehouse. The data warehouse may provide a table 1504 that houses the RDSourceNumID 1504a and Description to assist in identifying where the business' data originates. This feature supports a variety of operations.

Single Source types (where there are all one ERP and version, such as JD Edwards World version A9.1), also referred to herein as homogenous, may have multiple source instances 1501, 1503 that may be housed in a single data warehouse. In contrast, Multiple Source types (where there are more than one ERP or more than one version of the same ERP we have defined as Heterogeneous), also referred to herein as heterogeneous, may have multiple source instances 1507, 1508 that all need to be housed in a single data warehouse. Archive Sources of either, Single Source, Multiple Homogenous Sources or multiple Heterogeneous Sources may need to be available in the data warehouse since they are no longer available in the source application(s).

FIG. 15 illustrates how the ETL processes 1502, 1504, 1505, 1506 may move the data from the various sources into the CustomerDimension 1504. As shown in this example, the JD Edwards has an RDSourceNumID of 10001, the JD Edwards 2 has an RDSourceNumID of 10002, the PeopleSoft source has an RDSourceNumID of 30001, while the E-Business source has an RDSourceNumID of 40001. With these embodiments a customer may have all the source data in a clean cohesive manner for consumption by a business intelligence and other applications.

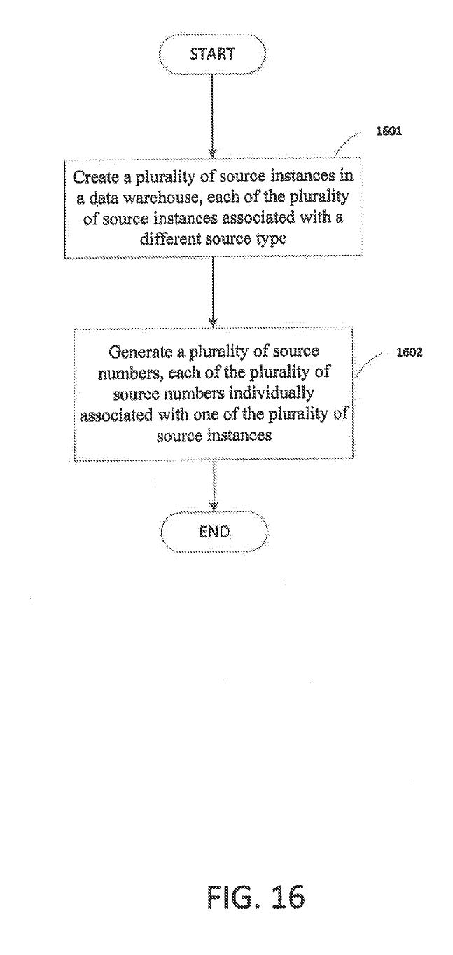

FIG. 16 is a flow diagram depicting a method for providing multisource control in certain embodiments. At block 1601 the system may create a plurality of source instances in a data warehouse, each of the plurality of source instances associated with a different source type. At block 1602 the system may generate a plurality of source numbers, each of the plurality of source numbers individually associated with one of the plurality of source instances.

In some embodiments, a customer may periodically like to use a business intelligence system to verify the validity of data. Since the BI's system source is the data warehouse, the data warehouse should provide the Auditing information. Auditing, as defined here, is the date and time of the Add of a record, the last Change date and time, and the record Deletion date and time. Additionally a special type of Delete called a Purge may be supported in certain embodiments. A Purge is a delete of many records for the primary purpose of shrinking the stored data size. Purges may be performed based on an organization's data retention requirements.

Certain embodiments contemplate integrating the Add, Change, Delete and Purge into all of the data warehouse tables in the data warehouse to the customer experience. The data warehouse may be configured to recognize the Purge user(s) or program(s) as established in the installation process. The data warehouse will mark each record as Add, Change, Delete or Purge and include the corresponding date based on the source system's related operation. Certain embodiments of the data warehouse will retain the Deletes and the Purges but mark them so they are available for reporting.

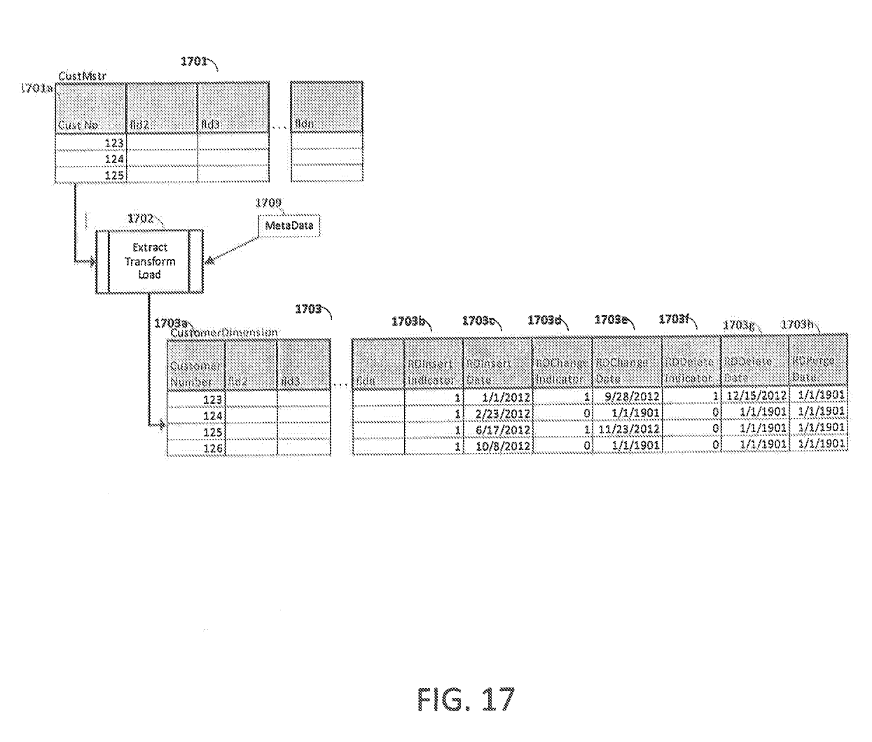

FIG. 17 illustrates the process of moving a source system table 1701 via an ETL process 1702 into a dimension table 1703, and shows the seven (7) fields that are included with all tables in certain embodiments of the data warehouse. Those fields are: RDInsertIndicator 1703b, RDInsertDate 1703c, RDChangeIndicator 1703d, RDChangeDate 1703e, RDDeleteIndicator 1703f, RDDeleteDate 1703g, and RDPurgeDate 1703h. In one system customers can now not only do all the BI analysis they need but can also get the auditing desired or required in some cases. These embodiments eliminate the need for a separate purchase of archival data reporting solutions. These embodiments also eliminate the need to integrate the archive data into the data warehouse in a custom effort.

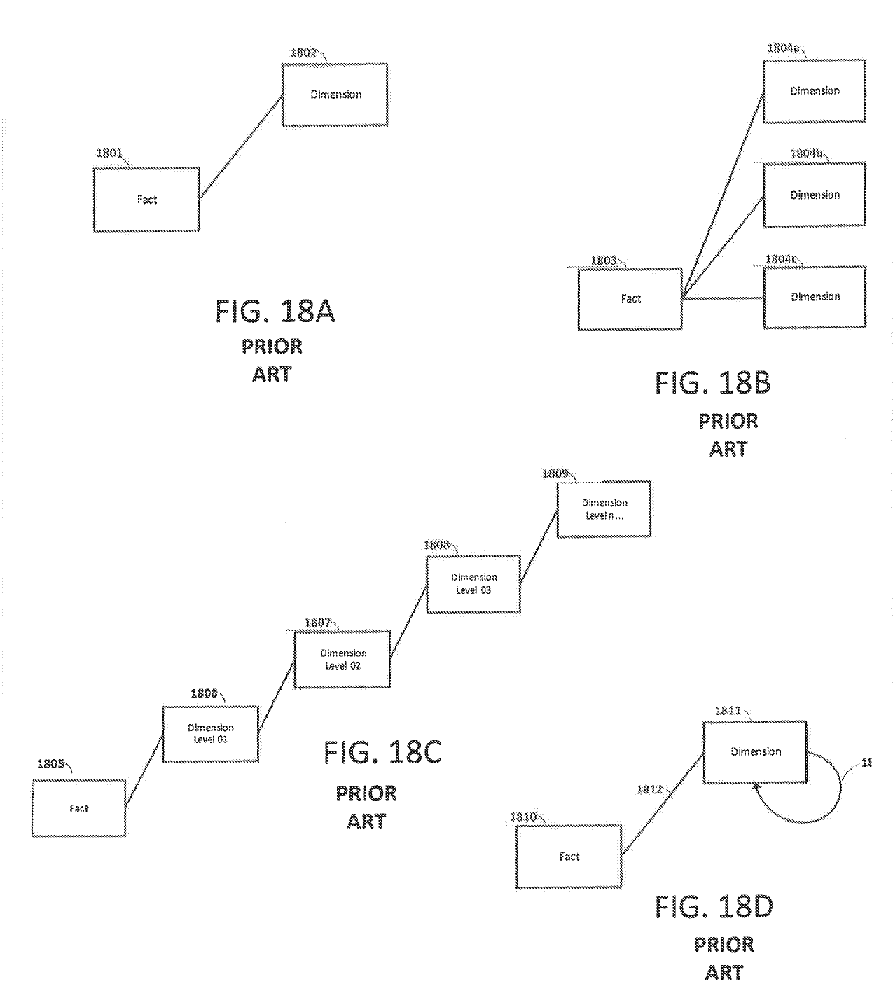

In some implementations, many subject areas have dimensions that have hard and fast or implied hierarchies. In a date hierarchy for example, any date may have a parent month that has a parent quarter that has a parent year. However, there are many times when alternate hierarchies can exist. A date can, alternatively, roll up to a week, that rolls up to a year. In this alternative case, weeks do not roll up to a month since a week can be split between months and contain dates from two months. Customers may also need to have corporate defined hierarchies such as dates that roll up to Fiscal or Financial Periods which are not months. Customers may need this flexibility to enhance their reporting capabilities. Four solutions in the industry are generally illustrated in FIGS. 18A-D.

FIG. 18A illustrates how some solutions build a very large, and complex, single dimension table 1802 for a hierarchy concept, like dates, that have all the required fields for all of the defined hierarchies. The issue with this is the sheer size of the dimension table. It is large to a point that it will not perform well. This industry solution is typically ever-changing as the company modifies, or defines additional, hierarchies.

FIG. 18B illustrates how some industry solutions build large dimension tables for a dimension concept like dates but creates one table per hierarchy such as one table for Calendar Monthly 1804a, one for Calendar Weekly 1804b, and one for the Fiscal Calendar 1804c. Each table has all the required fields for all the hierarchy definition of the table. The issue with this is the sheer size of the dimension table. It is large to a point that it will not perform well but better than the one above in FIG. 18A. With this implementation, the user will not be able to start drilling up or down on one hierarchy and then transfer to drilling on another hierarchy with ease. This industry solution is typically ever-changing as the company defines additional or changes existing hierarchies.

FIG. 18C illustrates how some industry solutions build large snowflakes for a dimension concept per hierarchy, for example with the dates dimension, there could be one snowflake dimension for calendar monthly 1806, one for calendar weekly 1807, and another for calendar fiscal 1808 and other levels 1809. The benefit to this is that no individual table is all that large. The problem with this is the number of joins from the fact 1805, to use the data in a report is large. As the hierarchies are changed or adjusted the tables need to be changed, deleted or others added. With this implementation, the user will not be able to start drilling up or down on one hierarchy and then transfer to drilling on another hierarchy with ease.

FIG. 18D shows the final iteration of the industry solutions is the same as in FIG. 18C, but instead of having a separate table for each level of the dimension snowflake, you have one table 1811 joined 1812 to fact 1810 and joined to itself as many times as required for the number of levels. The benefits are same as above plus the additional benefit of not needing to add or delete tables as hierarchy's changes. The problems remain the same as above but the joins to pull data out of the data warehouse to use in reporting are more complex.

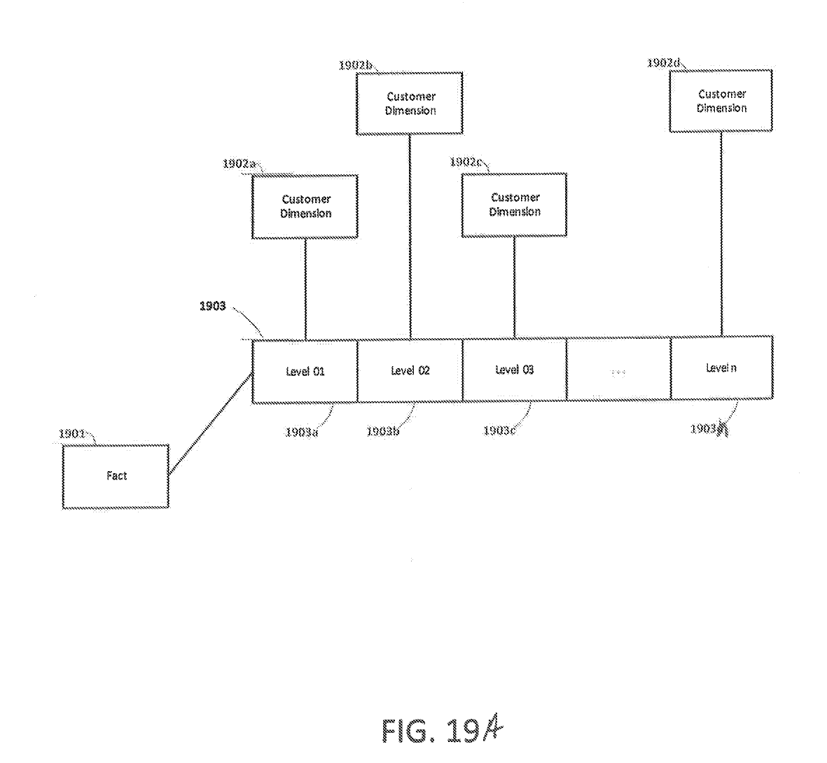

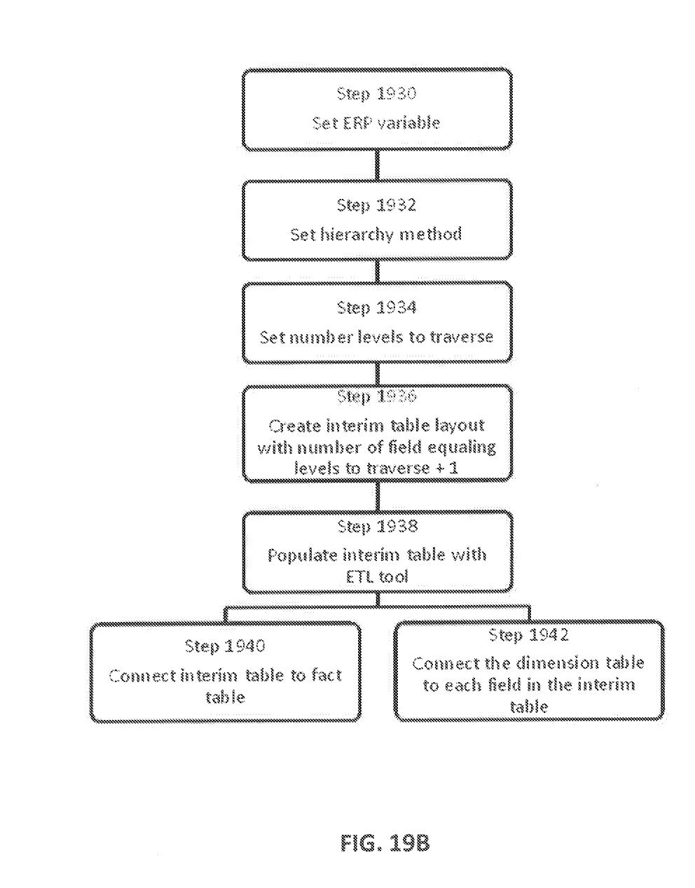

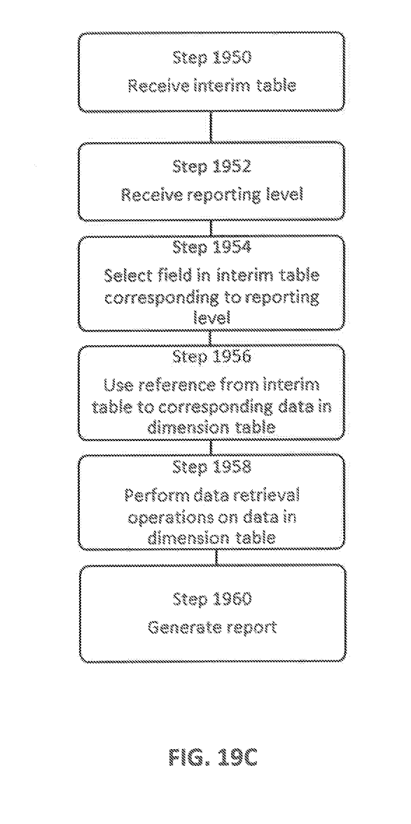

FIG. 19A illustrates the method of utilizing hierarchies in certain of the embodiments, overcoming certain of the deficiencies of the structures of FIGS. 18A-D. The solution includes a table 1902a-d that has a record format containing all data required for all levels of the hierarchies. All the records are in this one table. As an example all customers, regardless of where they are in a hierarchy, be they a Bill-To, Ship-To, or Sold-To customer, for example, are stored in one table.

The embodiment of FIG. 19A may use an interim table 1903 between the fact 1901 and the dimension 1902a-1902d where the interim table that contains keys (DSKs) to the appropriate records at every level of the hierarchy. As business requirements change, and hierarchy reporting requirements change, the only table that needs to be adjusted is the interim hierarchy table. The performance impact every query has on the dimension may be the same regardless of which level 1903a-1903n is chosen to report on, thus providing consistency of expectations. In these embodiments, the maintenance of the dimension is simpler, the ease of use in BI metadata design and reporting is improved, and drilling from one hierarchy to any other is easy and efficient, as compared to the systems of FIGS. 18A-D.

FIG. 19B is a flowchart of an exemplary method of generating an interim table, for example, the interim table shown in FIG. 19A. In step 1930, an enterprise resource planning (ERP) variable is received or set. The ERP variable may indicate a set of loading parameters associated with the type of the source table from which to load in data. Since different sources may have different loading parameters, the use of the ERP variable enables generation and use of an interim table from any type of source table. In step 1932, a hierarchy method is received or set. The hierarchy method indicates, for example, parent-child relationships embodied in the hierarchical data of the source table. In step 1934, a number of levels-to-traverse is received or set. The number of levels may be the number of levels in a hierarchy that need to be traversed in order, for example, to generate a report. The number of levels-to-traverse is used to determine the number of fields required in the interim table.

In step 1936, a layout is created for the interim table in which the number of fields of the interim table is determined based on the number of levels-to-traverse. In one exemplary embodiment, the number of fields in the interim table is set to one more than the number of levels-to-traverse. Nonetheless, other methods of determining the number of fields of the interim table are within the scope of this invention. In one embodiment, the interim table may include a set of hierarchy dimension indices with each hierarchy dimension index in the interim table corresponding to a level in the hierarchy of the dimension table. In step 1938, the interim table is populated with data from the source table using a suitable ETL tool. In one exemplary embodiment, the interim table is loaded to contain keys (DSKs) to the appropriate records at every level of the hierarchy. In step 1940, the interim table is connected to the fact table by including references to the keyed elements of the fact table. In step 1942, the interim table is connected to the dimension table by including references to the keyed elements of the dimension table. Each hierarchical level of data in the dimension table is thereby connected to data in the fact table via corresponding fields in the interim table. The fields of the interim table can thereby be used in generating reports at any desired level of hierarchy. Additionally, data can be drilled into and/or rolled up at and across any desired levels of hierarchy using the interim table.

FIG. 19C is a flowchart of an exemplary method of using an interim table to generate a report. In step 1950, an interim table is received or generated as shown in FIG. 19B. In step 1952, a reporting level in the data hierarchy is received or selected. In step 1954, exemplary embodiments determine a field in the interim table that corresponds to the selected reporting level. In step 1956, exemplary embodiments use the connections between the interim table and the dimension table to refer to data in the dimension table that correspond to the selected interim table field and thereby the selected reporting level. In step 1958, exemplary embodiments perform data retrieval operations on data at the selected reporting level, for example, by retrieving the data, rolling up in the hierarchy, drilling down into a hierarchy, and the like. In step 1960, the retrieved data may be processed to generate a report.

By making use of the references in the interim table to the fact and dimension tables, exemplary embodiments significantly improve the speed and efficiency with which hierarchical data may be accessed at any desired level. The use of the interim table enables a user to start drilling up or down on one hierarchy and then transfer to drilling through another level with ease and at high speed. A rolling format can be used or altered by, for example, resetting the offset distance to identify which level in an interim table is used to retrieve the appropriate data. Additionally, the interim table may be altered to provide for a change in reporting without needing to change the dimension.

FIG. 20 illustrates a method used in certain embodiments to build a dates dimension. This includes an ETL 2002 step to load dates into a file 2003, a second ETL process 2004 can be used to extract 2005, transform and load 2006 into the same file. This method allows for many different date hierarchies as well as unique information previously unavailable to Business Intelligence systems.

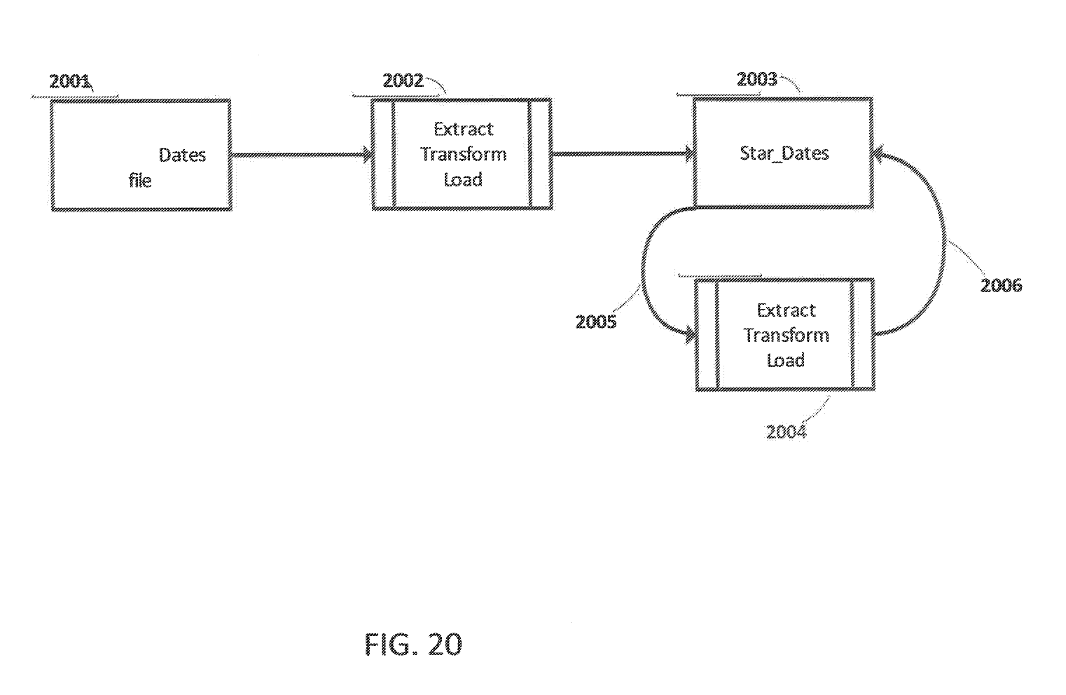

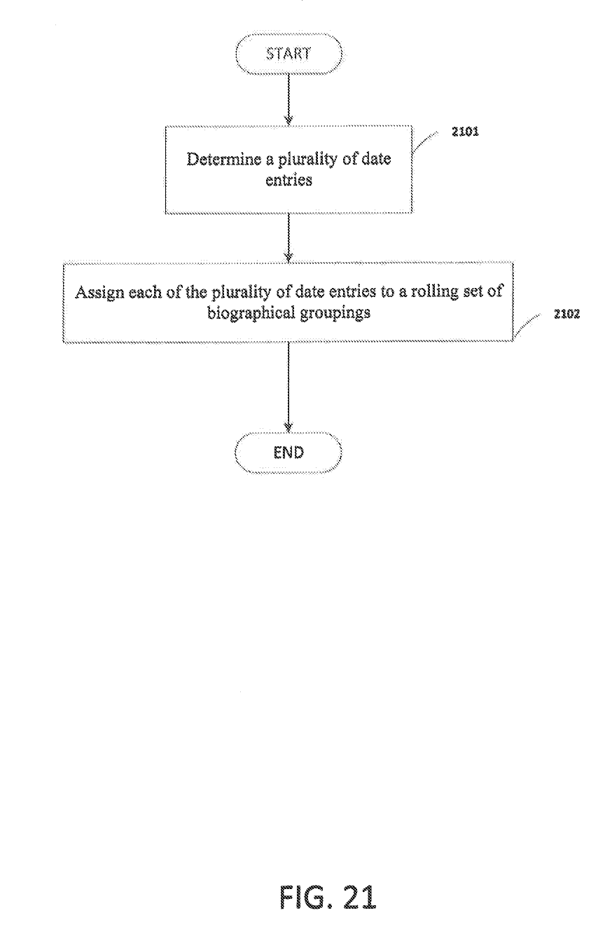

FIG. 21 is a flow diagram depicting a method used in certain embodiments to create a dates dimension. At block 2101 the system may determine a plurality of date entries. These date entries may have been previously created by a user of a source application. The date entries may be in a format depicting the entirety of the date information, e.g., MM-DD-YYYY. At block 2102 the system may assign each of the plurality of date entries to a rolling set of biographical groupings. The biographical groupings may be organized in a hierarchy and stored in a single table, e.g., table 1803 as depicted in FIG. 18B. In some embodiments, the system may assign the date entries to the rolling set of biographical groupings at the end of an operational day.

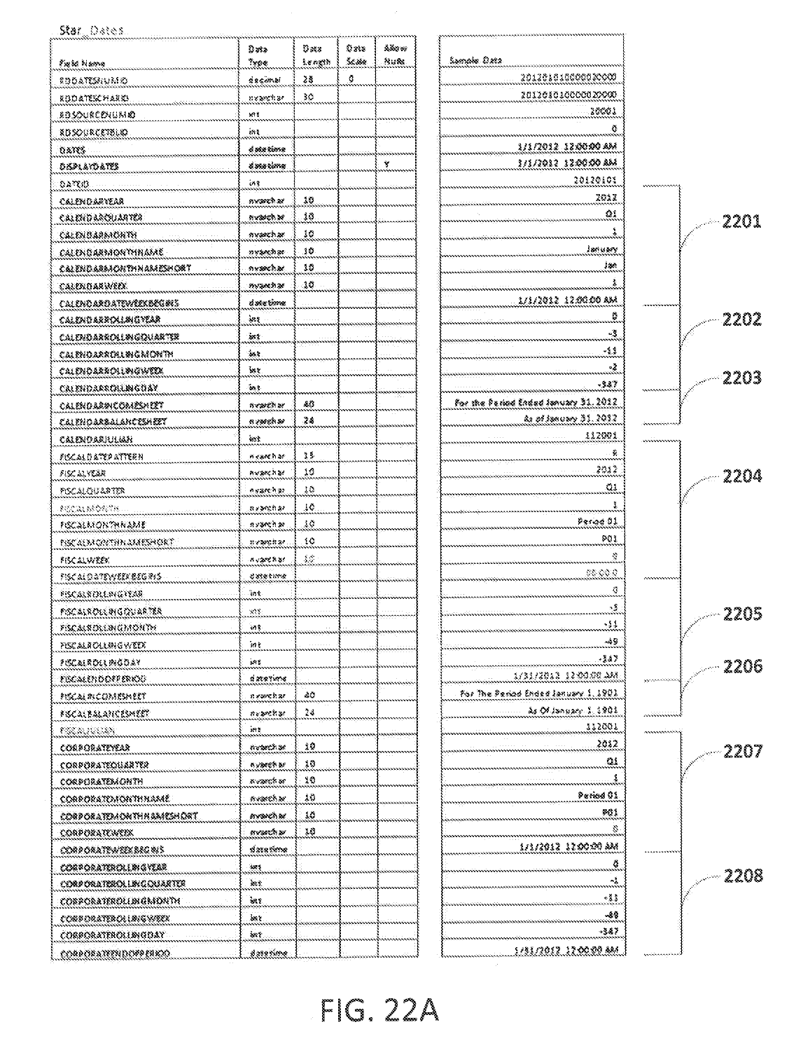

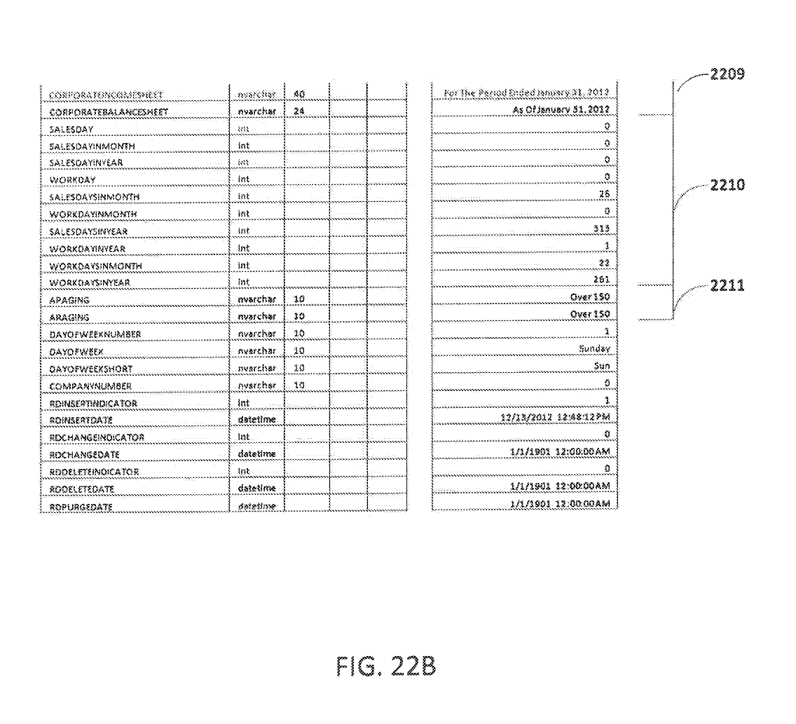

FIGS. 22A-B illustrates how the structure of FIG. 19A provides many unique value propositions in the dates dimension. Biographical information regarding Calendar Information 2201, Fiscal Information 2204, and a “Roll Up” to Corporate Fiscal Information 2207 is vast. Rolling information is included at entries 2202, 2205, 2208. Over time, rolling periods may become a valuable tool for measuring data. In a rolling solution, each night the dates are assigned to a rolling set of biographical groupings. This rolling set can be altered using the interim table.

Certain embodiments adjust the dates dimension which is significantly smaller and is related to the data. Certain embodiments have separate sets of rolling biographical information for: Calendar 2202, Fiscal 2205, and Corporate Fiscal 2208, 2210. These embodiments may provide a way for the end user community to no longer need to do the complex formatting required for Financial Reporting titles 2203, 2206, 2209. The process may either not exist, be hard-coded, or be limited in nature. Certain embodiments provide the Financial Reporting titles as fields to simply display on any report. The Financial Reporting Titles definitions may be created using key information inherited from the source system through an ETL process as described herein.

These embodiments provide ways for customers to easily, quickly, and reliably perform Accounts Payable and Accounts Receivable aging 2211, for example. These embodiments mitigate the need for an automated process to run over the vast amount of fact data to summarize and put into aging buckets each measure required by the end user community. This automated process may be volatile, invasive and very time consuming.

By contrast, by using the above-described dates dimension that may be updated once per day, a user can see the real time fact data in the aging buckets as defined in the source application. The aging buckets definition and ranges are inherited through the ETL process and used to calculate the aging buckets. The end user reporting community experience, and flexibility in using the data, is greatly improved. The ability to do Accounts Payable and Accounts Receivable aging on real-time data provides considerable benefit.

In the JD Edwards ERP system's General Ledger module, for example, the Account Master information is used to build an Account Dimension. Unfortunately, the Account Master table is one in which each record in the table (Child) is related to another record (The Parent) in the table. The only exception to this is the ultimate parent. This table however, does not carry on the record of the key field to the parent record. The parent is defined algorithmically as the record within the same business unit, with a lower magnitude value and a lower level of detail.

Many industry solutions, including custom solutions, build hundreds of lines of custom code to rebuild this hierarchical dimension. This operation may only be done on a rebuild/refresh basis. In contrast, present embodiments contemplate a way to resolve this issue utilizing a transform of Parent/Child and Hierarchy/Flattening in a unique manner, and building the logic to do the hierarchy maintenance in a continuously fed manner by a business unit. For example, SAP Data Services (DS) Transforming may be used.

Thus, in preferred embodiments, derived surrogate keys are generated and retained to identify parent records with hierarchy maintenance. Consequently, the customer's business end user can see the latest hierarchy without requiring a lengthy, volatile and invasive process.

Generally, customers want 100% reliable data. Customers want the solution to be the minimum definable impact to their production systems, their network, their data warehouse, and their BI systems. They want their data to be available in their BI systems in near real time. They want multiple tenants to be housed in the data warehouse.

Many industry approaches to data warehousing use refresh based processing. In a refresh, users may be logged out of the BI system and all or part of the data warehouse may be cleared. Large queries may be run on production system tables and all the data may be moved across the network. The data may be loaded to the data warehouse and mass calculations performed. Users may then be allowed back into the BI system. 100% of this data may be moved to try and synchronize the production system and the data warehouse even though a small fraction (<1%) of the data has typically changed. In some instances, 100% reliable data is not a possibility unless you can also quiesce the production system. Generally, this is not a reasonable assumption. As such, the data warehouse will always have out of sync anomalies. Generally a refresh is not the real-time solution a customer desires. Many data warehouses are designed for single tenants and avoid the customizations which must be designed, implemented and tested to achieve multi-tenancy.

Certain embodiments contemplate instantiating and establishing (publishing) a monitoring of the source database logs that capture every Add, Change and Delete of records. These embodiments may use logs as they are the only known method for identifying 100% of a database record's, adds, changes, and deletes. Certain embodiments use SAP Data Services as the ETL mechanism to move data. SAP Data Services is capable of refresh and is capable of reading the Published log. Certain embodiments of the data warehouse may perform an initial load of the product using SAP Data Services to do the refresh by programming SAP Data Services with appropriate metadata. SAP Data Services processes the log of data changes after the refresh so as to establish a “Full Synchronization” of the production system and the data warehouse. Certain embodiments create SAP Data Services metadata in the form of projects that have jobs to now control the Change Data Capture (near Real Time) movement of data. In some embodiments, the solution moves only the adds, changes, and deletes, as they occur. This advantageously achieves a more minimal definable impact to the source, network, data warehouse, and BI systems.

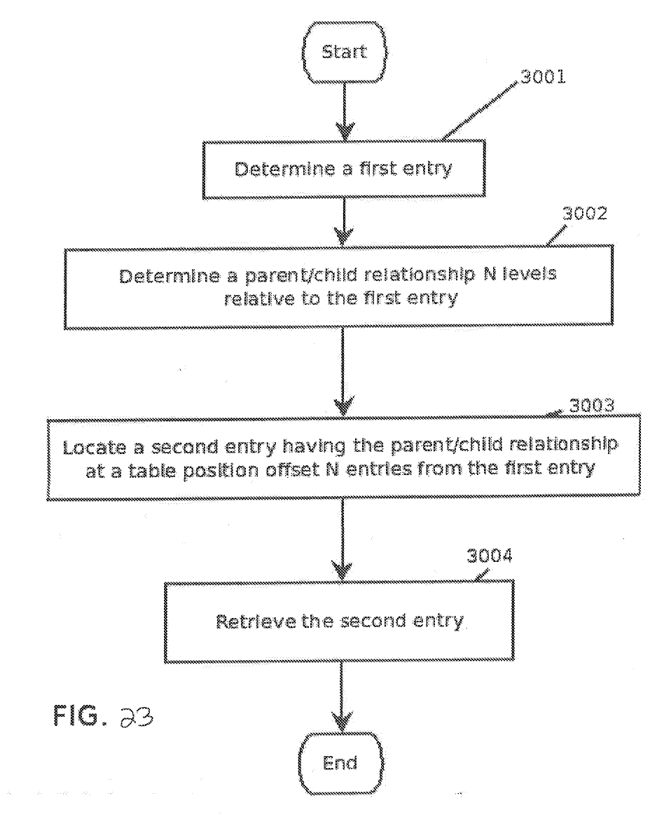

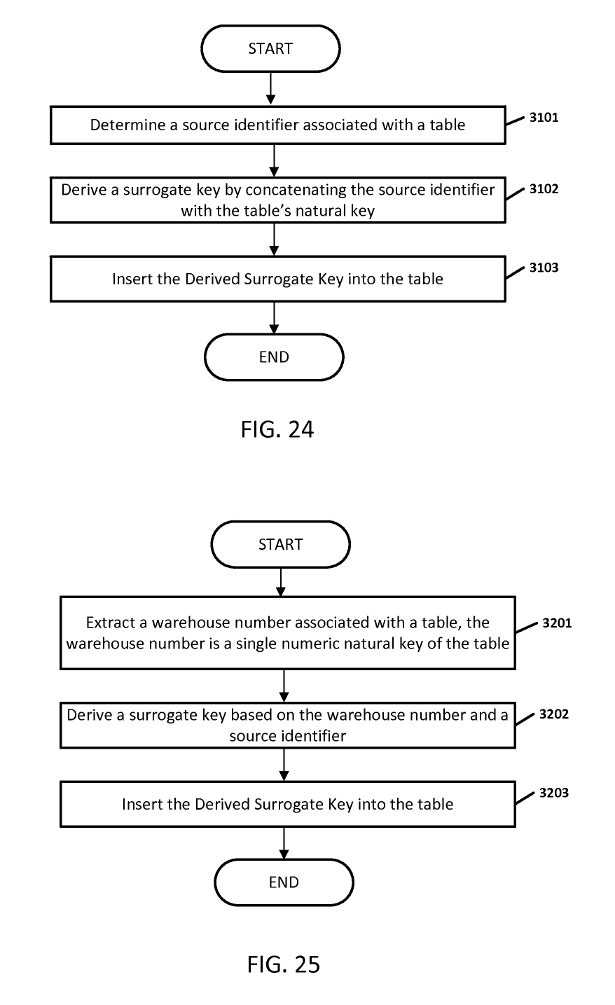

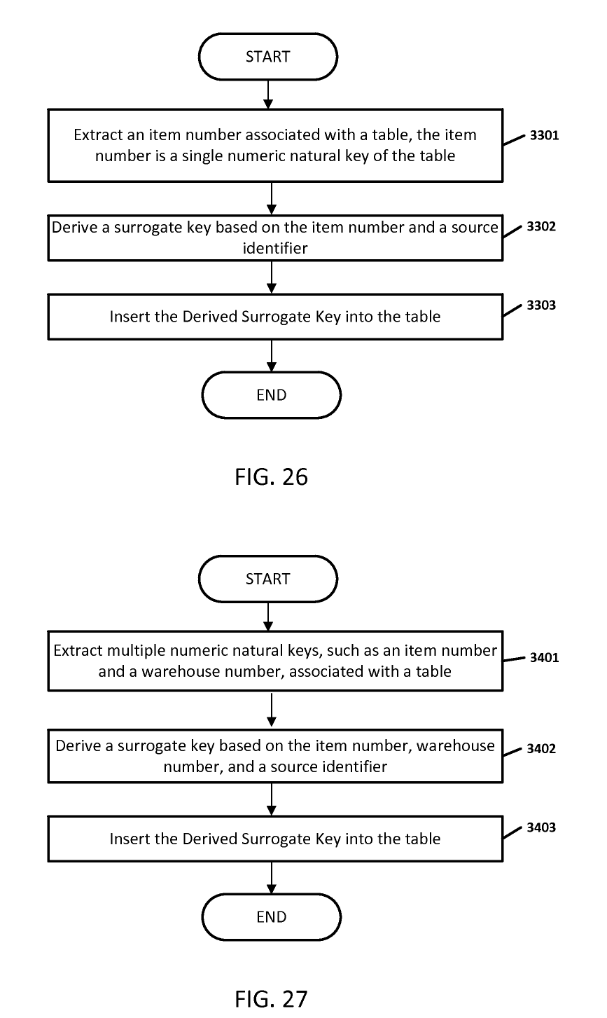

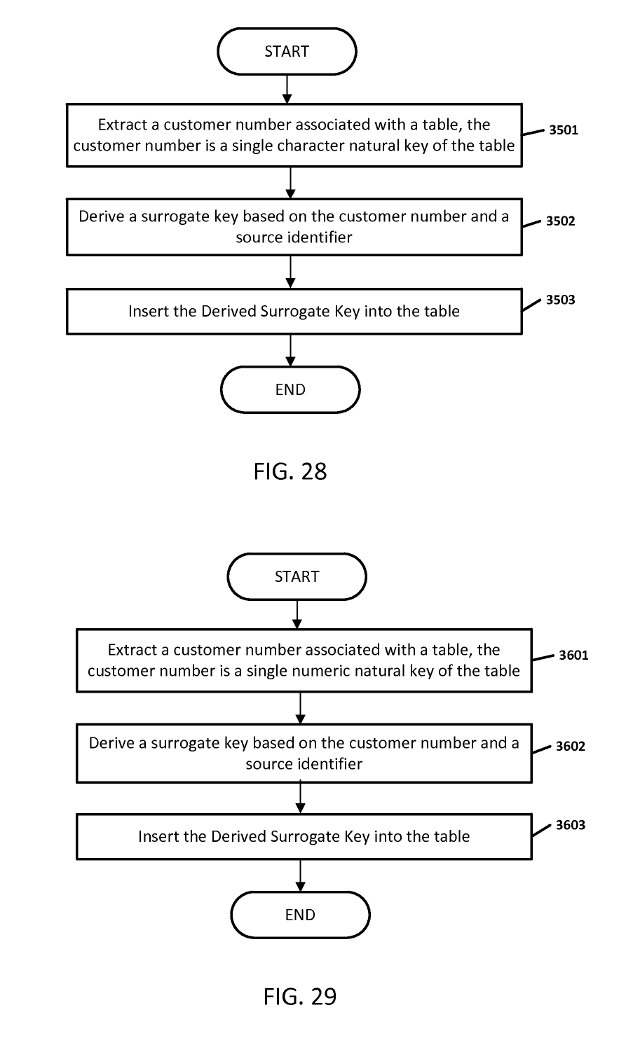

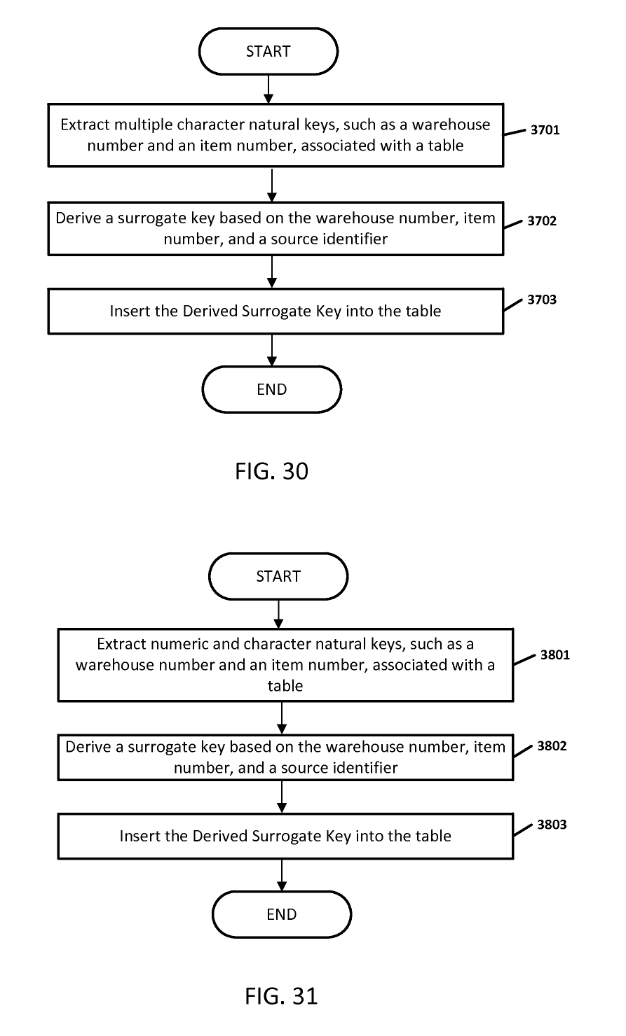

FIG. 23 is a flow diagram depicting certain steps in a process for traversing a hierarchical table such as the Table of FIG. 19A. At block 3001 the system may identify a first entry in a table, and at block 3002 may determine a parent/child relationship for the first entry. For example, the entry may be a “city” value and the system may be searching for a corresponding “state” or “nation” value. At block 3003 the system may locate a first entry having the parent/child relation at a corresponding offset distance. For example, the “state” may be one level in the hierarchy relative to the “city” and the second entry corresponding to the “state” will be located one index away. A “nation” value can be two levels higher and may accordingly be offset two indices from the “city” entry. In this manner, the system may use the location of the entries in the table to infer the hierarchical relation and to quickly access and retrieve 3004 data based thereon. Thus, an offset distance is used to select the proper level for search of the dimensions. FIGS. 24-31 are flow diagrams indicating a plurality of methods for forming derived surrogate keys based on selected parameters. These can determine 3101 source identifiers and concatenating with a natural identifier 3102 to generate and insert 3103 the DSK into a table. FIG. 25 illustrates generating 3201, 3202 and insertion 3203 based on warehouse number. FIG. 26 generates 3301, 3302 and inserts 3303 based on concatenation with item number. FIG. 27 generates 3401, 3402 and inserts based on another formula with the item number. Other field values 3501, 3601, 3701 and 3801 can also be used.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts, systems and methods of preferred embodiments of the invention are provided herein for illustrative purposes and are non-limiting examples thereof. One of ordinary skill in the art will recognize that exemplary systems and methods and equivalents thereof may include more or fewer steps than those illustrated in the exemplary flowcharts, and that the steps in the exemplary flowcharts may be performed in a different order than the order shown in the illustrative flowcharts.

1. A computer system for managing a data warehousing system, the computer system comprising:
a memory storing a first table; and
a processor configured to implement an extraction transaction and loading (ETL) tool to:
extract a first field value from the first table,
generate a derived surrogate key based on the first field value and a second identifier, and
insert the derived surrogate key into a second table.

2. The computer system of claim 1, wherein the derived surrogate key is a concatenation of the first field value and the second identifier.

3. The computer system of claim 1, wherein the first field value is a source identifier associated with a dimension table, the second identifier being a natural identifier associated with the dimension.

4. The computer system of claim 1, wherein the first field value is a customer number.

5. The computer system of claim 1, wherein the first field value is an item number.

6. The computer system of claim 1, wherein the first field value is a warehouse number.

7. The computer system of claim 1, wherein the derived surrogate key comprises a fact dimension appended to a fact.

8. The computer system of claim 7, wherein the fact is a transaction.

9. The computer system of claim 8, wherein the transaction is a sale.

10. The computer system of claim 7, wherein the fact is a source number and the fact dimension is a source identifier.

11. The computer system of claim 7, wherein the fact is an item number and the fact dimension is an item identifier.

12. The computer system of claim 7, wherein the fact dimension is appended to the fact by multiplying the fact dimension by an offset value to generate an offset fact dimension and adding the offset fact dimension to the fact, the offset value larger than the largest value of the fact in the system.

13. The computer system of claim 1, wherein the ETL tool further inserts the derived surrogate key into a third table.

14. The computer system of claim 13, wherein the first table is a fact table and the second table is a dimension table.

15. A computer-implemented method for managing a data warehousing system, the method comprising:
receiving a fact table;
receiving a dimension table, the entries of the dimension table organized in a hierarchy;
determining, based on the hierarchy of the entries of the dimension table, one or more hierarchy dimension indices corresponding to the entries of the dimension table;
generating an interim table associated with the fact table and the dimension table, the interim table comprising the one or more hierarchy dimension indices configured to reflect the hierarchy of the entries of the dimension table; and
storing the interim table on a storage device.

16. The method of claim 15, further comprising:
looking up an entry in the dimension table using at least one of the hierarchy dimension indices in the interim table.

17. The method of claim 15, wherein the one or more hierarchy dimension indices comprise one or more keys of the entries of the dimension table at one or more levels of the hierarchy.

18. The method of claim 17, wherein the step of generating an interim table further comprises generating a key at each hierarchical level of the entries in the dimension table.

19. The method of claim 15, wherein the one or more hierarchy dimension indices comprise a linear collection of references into the dimension table, the references indicating hierarchical associations between elements of the entity table.

20. The method of claim 15, wherein the dimension table is a customer table.

21. The method of claim 15, wherein the dimension table is a dates table.

22. The method of claim 15, further comprising:
assigning entries in the dimension table to a rolling set of biographical groupings, the biographical groupings reflecting the hierarchy in the dimension table.

23. The method of claim 22, wherein the entries in the dimension table are assigned to the rolling set of biographical groupings on a periodic basis.

24. The method of claim 22, wherein the biographical groupings include at least one of calendar, fiscal, and corporate fiscal groupings.

25. The method of claim 15, further comprising:
generating aging bucket definitions and ranges that are inherited through an extraction transaction and loading (ETL) process.

26. The method of claim 18 wherein the step of generating a key comprises generating a derived surrogate key.

27. The method of claim 26 further comprising generating the derived surrogate from a first field value and a second identifier.

28. The method of claim 27 wherein the step of generating the derived surrogate key comprises forming a concatenation of the first field value and the second identifier.

29. The method of claim 27 wherein the second identifier is obtained from a dimension table.

30. A computer system for managing a data warehousing system, the computer system comprising:
a memory storing a fact table and a dimension table having a primary key, the entries of the dimension table organized in a hierarchy; and
a processor configured to generate an interim table associated with the fact table and the dimension table, the interim table comprising a hierarchy dimension index configured to reflect the hierarchy of the entries in the dimension table.

31. The computer system of claim 30, wherein the dimension table is a customer table.

32. The computer system of claim 30, wherein the dimension table is a dates table.

33. The computer system of claim 30, wherein the hierarchy dimension index comprises a linear collection of references into the dimension table, the references indicating hierarchical associations between elements of the entity table.

34. The computer system of claim 30, wherein the hierarchy dimension index comprises a primary key at every hierarchical level of the entries in the dimension table.

35. The computer system of claim 30, wherein the processor is further configured to assign entries in the dimension table to a rolling set of biographical groupings, the biographical groupings reflecting the hierarchy in the dimension table.

36. The computer system of claim 35, wherein the entries in the dimension table are assigned to the rolling set of biographical groupings on a periodic basis.

37. The computer system of claim 35, wherein the biographical groupings include at least one of calendar, fiscal, and corporate fiscal groupings.

38. The computer system of claim 30, wherein the processor is further configured to generate aging bucket definitions and ranges that are inherited through an ETL process.

39. The computer system of claim 30, wherein the processor is further configured to look up a first entry in the dimension table based on an associated hierarchy dimension index in the interim table.

40. The computer system of claim 34 wherein the key comprises a derived surrogate key based on a first field value and a second identifier.
